(19) United States
(12) Patent Application Publication
(10) Pub. No.: US 2016/0171297 A1
(43) Pub. Date: Jun. 16, 2016

(54) METHOD AND DEVICE FOR CHARACTER INPUT

(71) Applicant: THOMSON LICENSING, Issy-les-Moulineaux (FR)

(72) Inventors: Peng QIN, Beijing (CN); Lin DU, Beijing (CN); Guanghua ZHOU, Beijing (CN)

(21) Appl. No.: 14/392,202

(22) PCT Filed: Jun. 25, 2013
(86) PCT No.: PCT/CN2013/077832

§ 371 Date: Dec. 23, 2015

(51) Int. Cl. G06K 9/00; G06T 7/20; G06F 1/32; G06F 3/01; G06F 3/00

(52) U.S. Cl. CPC G06K 9/00416; G06F 3/017; G06F 3/005; G06F 1/325; G06T 7/20; G06T 2207/30241

(57) ABSTRACT

It is provided a method for recognizing character input by a device with a camera for capturing a moving trajectory of an inputting object and a sensor for detecting a distance from the inputting object to the sensor, wherein comprising steps of detecting distance from the inputting object to the sensor; recording the moving trajectory of the inputting object when the inputting object moves within a spatial region, wherein the spatial region has a nearest distance value and a farthest distance value relative to the sensor, and wherein moving trajectory of the inputting object is not recorded when the inputting object moves outside of the spatial region; recognizing a character based on the recorded moving trajectory.

### TECHNICAL FIELD

The present invention relates to user interaction, and more particularly relates to a method and a device for character input.

### BACKGROUND

With the development of gesture recognition technology, people become more and more willing to use handwriting as input means. The base of handwriting recognition is machine learning and training library. No matter what training database is used, a reasonable segmentation of strokes is critical. At present, most of the handwriting inputs are made on the touch screen. After a user finishes one stroke of a character; he will off contact his hand from the touch screen, so the input device can easily distinguish strokes from each other.

With the development of 3D (3 dimensions) devices, the demand for recognizing handwriting inputs in the air becomes more and more strong.

### SUMMARY

According to an aspect of the present invention, it is provided a method for recognizing character input by a device with a camera for capturing a moving trajectory of an inputting object and a sensor for detecting a distance from the inputting object to the sensor, wherein comprising steps of detecting the distance from the inputting object to the sensor; recording a moving trajectory of the inputting object when the inputting object moves within a spatial region, wherein the spatial region has a nearest distance value and a farthest distance value relative to the sensor, and wherein a moving trajectory of the inputting object is not recorded when the inputting object moves outside the spatial region; recognizing a character based on the recorded moving trajectory.

Further, before the step of recognizing the character the method further comprises detecting the inputting object is still within the spatial region for a period of time.

Further, before the step of recognizing the character the method further comprises determining a current stroke is a beginning stroke of a new character, wherein a stroke corresponds to moving trajectory of the inputting object during a period beginning when the inputting object is detected to move from outside of the spatial region into the spatial region and ending when the inputting object is detected to move from the spatial region to outside of the spatial region.

Further, the step of determining further comprises mapping the current stroke and a previous stroke to a same line parallel to an intersection line between a plane of display surface and a plane of ground surface of the earth to obtain a first mapped line and a second mapped line; and determining the current stroke is the beginning stroke of the new character if not meeting any of following conditions: 1) the first mapped line is contained by the second mapped line; 2) the second mapped line is contained by the first mapped line; and 3) the ratio of intersection of the first mapped line and the second mapped line to union of the first mapped line and the second mapped line is above a value.

Further, the device has a working mode and a standby mode for character recognition, the method further comprising putting the device in the working mode upon detection of a first gesture; and putting the device in the standby mode upon detection of a second gesture.

Further, the method further comprising enabling the camera to output moving trajectory of the inputting object when the inputting object moves within a spatial region; and disabling the camera to output moving trajectory of the inputting object when the inputting object moves outside the spatial region.

According to an aspect of the present invention, it is provided a device for recognizing character input, wherein comprising a camera 101 for capturing and outputting moving trajectory of an inputting object; a sensor 102 for detecting and outputting distance between the inputting object and the sensor 102; a processor 103 for a) recording moving trajectory of the inputting object outputted by the camera 101 when the distance outputted by the sensor 102 is within a range having a farthest distance value and a nearest distance value, wherein moving trajectory of the inputting object is not recorded when the distance outputted by the sensor 102 does not belong to the range; b) recognizing a character based on the recorded moving trajectory.

Further, the processor 103 is further used to c) putting the device in a working mode among the working mode and a standby mode for character recognition upon detection of a first gesture; and d) determining the farthest distance value and the nearest distance value based on distance outputted by the sensor 102 at the time when the first gesture is detected.

Further, the processor 103 is further used to c′) putting the device in a working mode among the working mode and a standby mode for character recognition upon detection of a first gesture; d′) detecting the inputting object is still for a period of time; and e) determining the farthest distance value and the nearest distance value based on distance outputted by the sensor 102 at the time when the inputting object is detected to be still.

Further, the processor 103 is further used to g) determining a current stroke is a beginning stroke of a new character, wherein a stroke corresponds to moving trajectory of the inputting object during a period beginning when the distance outputted by the sensor 102 becomes to be within the range and ending when the distance outputted by the sensor 102 becomes to be out of the range.

It is to be understood that more aspects and advantages of the invention will be found in the following detailed description of the present invention.

### BRIEF DESCRIPTION OF THE DRAWINGS

The accompanying drawings, which are included to provide a further understanding of the invention and are incorporated in and constitute a part of this application, will be used to illustrate an embodiment of the invention, as explained by the description. The invention is not limited to the embodiment.

In the drawings:

FIG. 1 is a diagram schematically showing a system for spatially inputting a character according to an embodiment of present invention;

FIG. 2 is a diagram showing the definition of the spatial region according to the embodiment of the present invention;

FIG. 3A is a diagram showing the moving trajectory of user hand captured and outputted by the camera 101 without using the present invention;

FIG. 3B is a diagram showing the moving trajectory of user hand after filtering out the invalid inputs according to the embodiment of present invention;

FIG. 4 is a flow chart showing a method for recognizing an input of a character according to the embodiment of the present invention;

FIG. 5 is a diagram showing the position relationship between a former character and a latter character according to the embodiment of the present invention; and

FIG. 6 is a diagram showing all possible horizontal position relationship between a former stroke and a latter stroke according to the embodiment of the present invention.

### DETAILED DESCRIPTION

The embodiment of the present invention will now be described in detail in conjunction with the drawings. In the following description, some detailed descriptions of known functions and configurations may be omitted for clarity and conciseness.

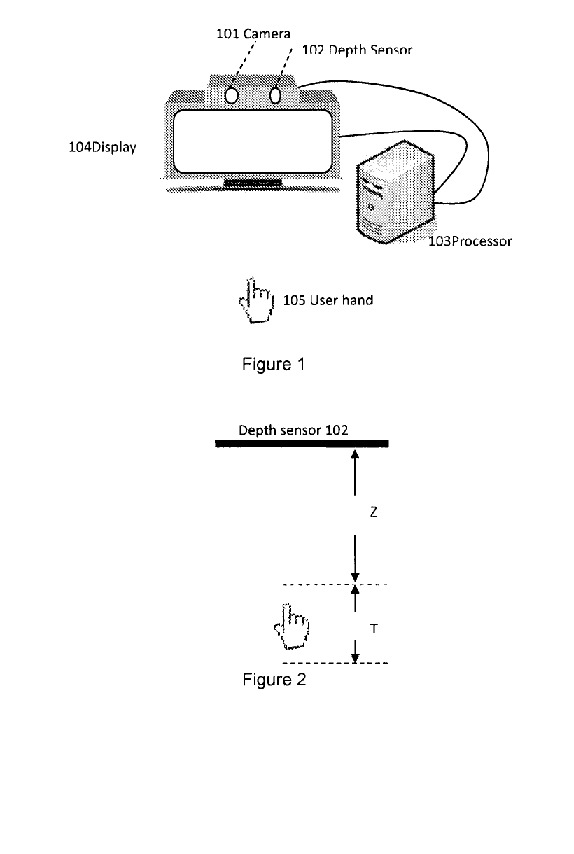

FIG. 1 is a diagram schematically showing a system for spatially inputting a character according to an embodiment of the present invention. The system comprises a camera 101, a depth sensor 102, a processor 103 and a display 104. The processor 103 is connected with the camera 101 and the depth sensor 102 and the display 104. In this example, the camera 101 and the depth sensor 102 are placed on the top of the display 104. It shall note the camera 101 and the depth sensor 102 can be placed at other places, for example, the bottom of the display frame, or on a desk that supports the display 104 etc. Herein, a recognizing device for recognizing a spatially inputted character comprises the camera 101, the depth sensor 102 and the processor 103. Moreover, a device for recognizing a spatially inputted character comprises the camera 101, the depth sensor 102, the processor 103 and the display 104. The components of the system have following basic functions:
the camera 101 is used to capture and output digital images;
the depth sensor 102 is used to detect and output the distance from the hand to the depth sensor 102. As to the candidate depth sensor, the following sensors can be used. OptriCam is a 3D time of flight (TOF) and other proprietary and patented technologies depth sensor, it operating in the NIR spectrum, it provides outstanding background light suppression, very limited motion blur and low image lag. GrayPoint's BumbleBee is based on stereo image and sub-pixel interpolation technology, which can get the depth information real time. PrimeSense light coding depth sensor use laser speckle and other technology.
the processor 103 is used to process data and output data to the display 104; and
the display 104 is used to display data it received from the processor 103.

The problem the present invention solves is that when the user uses his hand or other objects recognizable to the camera 101 and the depth sensor 102 to spatially inputs or handwrite two or more strokes of a character in the air, how the system ignores the moving trajectory of the hand between the beginning of a stroke and the end of its previous stroke (for example, between the beginning of the second stroke and the end of the first stroke of a character) and correctly recognize every stroke of the character. In order to solve the problem, a spatial region is used. As an example, the spatial region is defined by two distance parameters, i.e. the nearest distance parameter and the farthest distance parameter. FIG. 2 is a diagram showing the definition of the spatial region according to the embodiment of the present invention. In the FIG. 2, value of the nearest distance parameter is equal to Z, and value of the farthest distance parameter is equal to Z+T

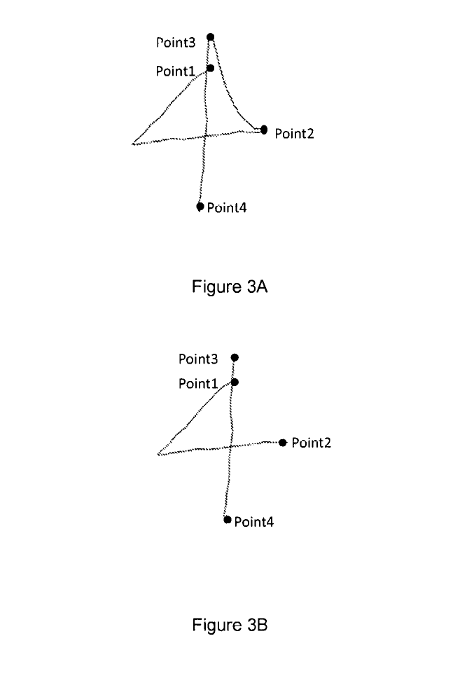

From the perspective of user interaction, the spatial region is used for the user to input strokes of the character. When a user wants to input a character, he moves his hand into the spatial region and inputs the first stroke. After the user finishes inputting the first stroke, he moves his hand out of the spatial region and then moves his hand into the spatial region for inputting a following stroke of the character. Above steps are iterative until all strokes are inputted. For example, the user wants to input a numeric character 4. FIG. 3A is a diagram showing the moving trajectory of user hand captured and outputted by the camera 101 without using the present invention. In other words, FIG. 3A also shows the moving trajectory of user hand without depth information (or called information on distance from the hand to the depth sensor). Herein, we use the FIG. 3 to show the spatial moving trajectory of the hand when the user wants to input 4. Firstly, the user moves his hand into the spatial region to write the first stroke from point 1 to point 2, then moves his hand out of the spatial region and moves his hand from point 2 to point 3, then moves his hand into the spatial region to write the second stroke of the character 4 from point 3 to point 4.

From the perspective of data processing, the spatial region is used by the processor 102 (it can be a computer or any other hardware capable of data processing) to distinguish valid inputs and invalid inputs. A valid input is the movement of hand within the spatial region and corresponds to one stroke of the character, and an invalid input is the movement of hand out of the spatial region and corresponds to movement of hand between the beginning of a stroke and the end of its previous stroke.

By using the spatial region, invalid inputs are filtered out and strokes of the character are correctly distinguished and recognized. FIG. 3A is a diagram showing the moving trajectory of user hand captured and outputted by the camera 101 without using the present invention when inputting number 4 before a camera. The number 4 consists of 2 strokes, i.e. trajectory from point 1 to point 2 and trajectory from point 3 to point 4. The movement of user hand starts with point 1 to point 4 through point 2 and point 3. However, the character recognition algorithm cannot correctly recognize it as the number 4 because the moving trajectory from point 2 to point 3. FIG. 3B is a diagram showing the moving trajectory of user hand after filtering out the invalid inputs according to the embodiment of present invention.

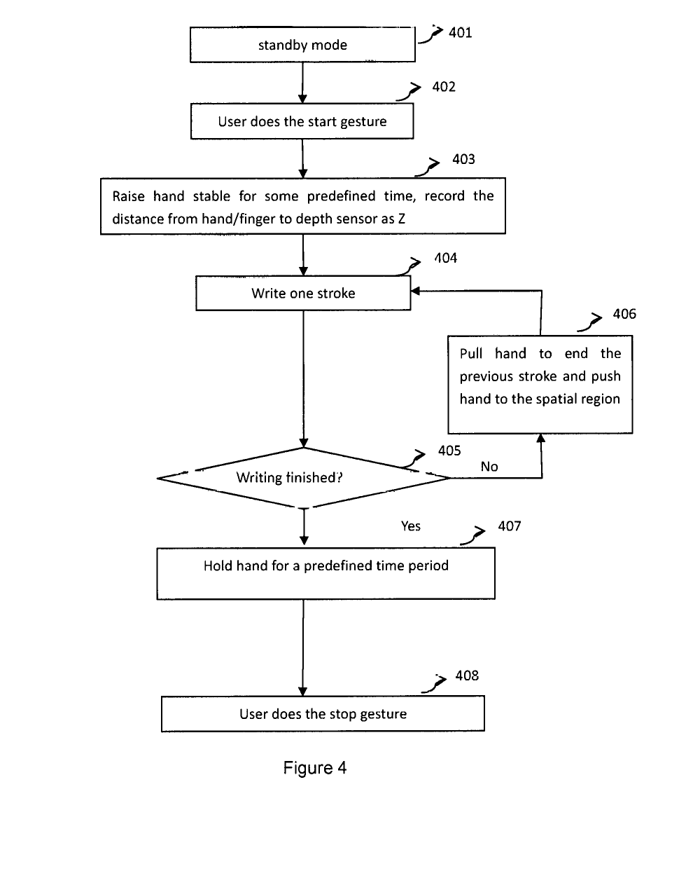

FIG. 4 is a flow chart showing a method for recognizing an input of a character according to the embodiment of the present invention. The method comprises the following steps.

In the step 401, the device for recognizing a spatially inputted character is in a standby mode in terms of character recognition. In other words, the function of the device for recognizing spatially inputted character is inactivated or disabled.

In the step 402, the device is changed to the working mode in terms of character recognition when the processor 103 uses camera 101 to detect a starting gesture. Herein, a starting gesture is a predefined gesture stored in the storage (e.g. nonvolatile memory) (not shown in the FIG. 1) of the device. Various existing gesture recognition approaches can be used for detecting the starling gesture.

In the step 403, the device determines a spatial region. It is implemented by user's raising his hand stably for a predefined time period. The distance between the depth sensor 102 and user's hand is stored in the storage of the device as Z as shown in the FIG. 2, i.e. the nearest distance parameter value. The T in the FIG. 2 is a predefined value, which is almost equal to human's arm length, i.e. 15 cm. A person skilled in the art shall note that other value for T is possible, for example, ⅓ of arm's length. So value of the farthest distant parameter is Z+T. In another example, the detected distance from the depth sensor to the hand is not used as the nearest distance parameter value, but used to determine the nearest distance parameter value and the farthest distance parameter value, for example, the detected distance plus some value, e.g. 7 cm is the farthest distance parameter value and the detected distance minus some value, e.g. 7 cm is the nearest distance parameter value.

In the step 404, the user moves his hand into the spatial region and inputs a stroke of a desired-to-input character. After the user finishes inputting the stroke, he decides if the stroke is the last stroke of the character in the step 405. If not, in the steps 406 and 404, he moves his hand out of the spatial region by pulling his hand and then pushes his hand into the spatial region for inputting a following stroke of the character. A person skilled in the art shall note the steps 404, 405 and 406 ensure that all strokes of the character are inputted. During the user input of all strokes of the character, from the perspective of the recognizing device, the processor 103 does not record all moving trajectory of the hand in the memory. Instead, the processor 103 only records the moving trajectory of the hand when the hand is detected by the depth sensor 102 to be within the spatial region. In one example, the camera keeps outputting the captured moving trajectory of the hand regardless of whether or not the hand is within the spatial region and the depth sensor keeps outputting the detected distance from the hand to the depth sensor. The processor records the output of the camera when it decides that the output of the depth sensor meets the predefined requirement, i.e. within the range defined by the farthest parameter and the nearest parameter. In another example, the camera is instructed by the processor to be turned off after the step 402, turned on when the hand is detected to begin to move into the spatial region (i.e. the detected distance begins to be within the range defined by the farthest parameter and the nearest parameter) and kept on while the hand is within the spatial region. During these steps, the processor of the recognizing device can easily determine and differentiate strokes of the character from each other. One stroke is the moving trajectory of the hand outputted by the camera during a period beginning when the hand moves into the spatial region and ending when the hand moves out of the spatial region. From the perspective of the recognizing device, the period begins when the detected distance begins to within the range defined by the farthest parameter and the nearest parameter and ends when the detected distance begins to out of the range.

In the step 407, if the user finishes inputting all strokes of the character, he moves his hand into the spatial region and holds it for a predefined period of time. From the perspective of the recognizing device, upon detecting by the processor 103 that the hand is held substantially still (because it is hard for human to hold hand absolutely still in the air) for the predefined period of time, the processor 103 begins to recognize the character based on all stored strokes, i.e. all stored moving trajectory. The stored moving trajectory looks like the FIG. 3D.

In the step 408, upon detecting a stop gesture (a predefined recognizable gesture in nature), the device is changed to the standby mode. It shall note that it does not necessarily require the hand to be within the spatial region when the user makes the stop gesture. In an example where the camera is kept on, the user can make the stop gesture when the hand is out of the spatial region. In another example where the camera is kept on when the hand is within the spatial region, the user can only make the stop gesture when the hand is within the spatial region.

According to a variant, the spatial region is predefined, i.e. values of the nearest distant parameter and the farthest distant parameter are predefined. In this case, the step 403 is redundant, and consequently can be removed.

According to another variant, the spatial region is determined in the step 402 by using the distance from the hand to the depth sensor when detecting the starting gesture.

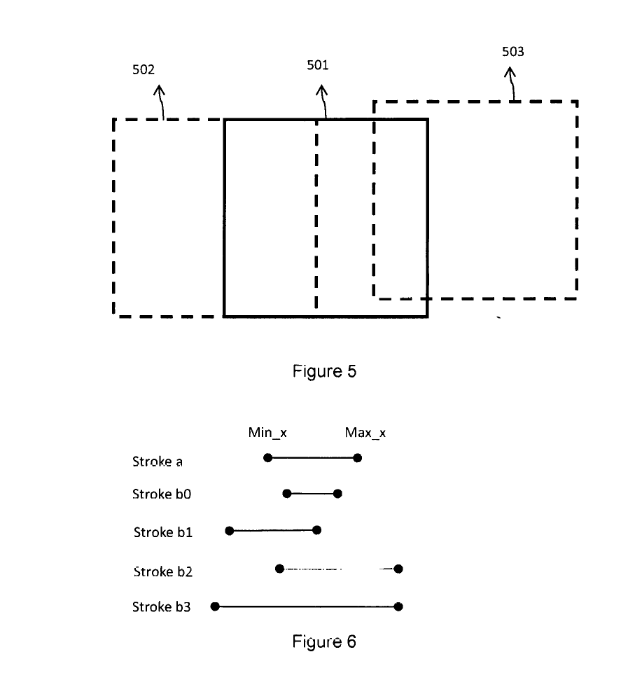

The description above provides a method for inputting one character. In addition, an embodiment of the present invention provides a method for successively inputting 2 or more characters by accurately recognizing the last stroke of a former character and the beginning stroke of a latter character. In other words, after the starting gesture in the step 402 and before holding hand for a predefined period of time in the step 407, more than 2 characters are inputted. Because the beginning stroke can be recognized by the device, the device will divide the moving trajectory into more than 2 segments, and each segment represents a character. Considering the position relationship between two successive characters inputted by the user in the air, it's more natural for the user to write all strokes of the latter character at a position to the left or to the right of the last stroke of the first former character. FIG. 5 is a diagram showing the position relationship between a former character and a latter character in a virtual plane vertical to the ground of the earth as perceived by the user. The rectangle in solid line 501 represents the region for inputting the former character, and the rectangles in dash line 502 and 503 represents two possible regions for inputting the latter character (not exhaustive). It shall note that in this example the position relationship means the horizontal position relationship. Below explains a method for determining the first stroke of a character if two or more characters are successively inputted.

Suppose the coordinate system's origin in the upper left corner, X axis (parallel to a line of intersection between a plane of display surface and a plane of ground surface of the earth) increases to the right orientation, Y axis (vertical to the ground surface of the earth) increases to the down orientation. And the user's writing habit is written horizontally from left to right. The width of each stroke (W) is defined as this way: W=max_x−min_x; max_x is the maximum X axis value of one stroke, min_x is the minimum X axis value of the stroke. W is the difference between these two values. FIG. 6 shows all possible horizontal position relationship between a former stroke (stroke a) and a latter stroke (stroke b0, b1, b2 and b3) when the former stroke and the latter stroke are mapping to X axis. The core concept is that the latter stroke and the former stroke belong to a same character if any of the following conditions is met: 1) the horizontally mapped line of the latter stroke is contained by the horizontally mapped line of the former stroke; 2) the horizontally mapped line of the former stroke is contained by the horizontally mapped line of the latter stroke; 3) the ratio of intersection of the horizontally mapped line of the former stroke and the horizontally mapped line of the latter stroke to their union is above a predefined value. Below is a pseudo-code showing how to judge a stroke is a beginning stroke of the latter character:
Bool bStroke1MinIn0=(min_x_1>=min_x_0) && (min_x_1<=max_x_0);
Bool bStroke1MaxIn0=(max_x_1>=min_x_0) && (max_x_1<=max_x_0);
Bool bStroke0MinIn1=(min_x_0>=min_x_1) && (min_x_0<=max_x_1);
Bool bStroke0MaxIn1=(max_x_0>=min_x_1) && (max_x_0<=max_x_1);
Bool bStroke1Fall0=bStroke0MinIn1 && bStroke0MaxIn1 ∥
   bStroke1MinIn0 && bStroke1MaxIn0 ∥
   bStroke1MinIn0 && !bStroke1MaxIn0 && ((float) (max_x_0−min_x_1)/(float)(max_x_1−min_x_0)>TH_RATE) ∥
   !bStroke1MinIn0 && bStroke1MaxIn0 && ((float)(max_x_1−max_x_0)/(float)(max_x_1−min_x_0)>TH_RATE);

TH_RATE shows the ratio of the intersection part of two successive strokes, this value can be set in advance.

According to the above embodiments, the device begins to recognize a character when there is a signal instructing the device to do so. For example, in the step 407, when the user holds his hand for a predefined period of time, the signal is generated; besides, when more than two characters are inputted, the recognition of the first stroke of a latter character triggers the generation of the signal. According to a variant, each time a new stroke is captured by the device, the device will try to recognize a character based on past captured moving trajectory. Once a character is successfully recognized, the device starts to recognize a new character based on a next stroke and its subsequent strokes.

A number of implementations have been described. Nevertheless, it will be understood that various modifications may be made. For example, elements of different implementations may be combined, supplemented, modified, or removed to produce other implementations. Additionally, one of ordinary skill will understand that other structures and processes may be substituted for those disclosed and the resulting implementations will perform at least substantially the same function(s), in at least substantially the same way(s), to achieve at least substantially the same result(s) as the implementations disclosed. Accordingly, these and other implementations are contemplated by this application and are within the scope of the invention as defined by the appended claims.

1. A method for recognizing character input by a device with a camera for capturing moving trajectory of an inputting object and a sensor for detecting distance from the inputting object to the sensor, wherein comprising steps of
detecting a distance from the inputting object to the sensor;
determining a moving trajectory of the inputting object when the inputting object moves within a spatial region, wherein the spatial region has a nearest distance value and a farthest distance value relative to the sensor; and
mapping a character based on the determined moving trajectory

2. The method of the claim 1, wherein before the step of mapping the character the method further comprises
detecting the inputting object is held still within the spatial region for a period of time.

3. The method of the claim 1, wherein before the step of mapping the character the method further comprises
determining a current stroke is a beginning stroke of a new character, wherein a stroke corresponds to the moving trajectory of the inputting object during a period beginning when the inputting object is detected to move from outside of the spatial region into the spatial region and ending when the inputting object is detected to move from the spatial region to outside of the spatial region.

4. The method of the claim 3, wherein the step of determining further comprises
mapping the current stroke and a previous stroke to a same line parallel to an intersection line between a plane of display surface and a plane of ground surface of the earth to obtain a first mapped line and a second mapped line; and
determining the current stroke is the beginning stroke of the new character if not meeting any of following conditions: 1) the first mapped line is contained by the second mapped line; 2) the second mapped line is contained by the first mapped line; and 3) the ratio of intersection of the first mapped line and the second mapped line to union of the first mapped line and the second mapped line is above a value.

5. The method of the claim 1, wherein the device has a working mode and a standby mode for character recognition, the method further comprising
putting the device in the working mode upon detection of a first gesture; and
putting the device in the standby mode upon detection of a second gesture.

6. The method of the claim 1, wherein the method further comprising
enabling the camera to output moving trajectory of the inputting object when the inputting object moves within a spatial region; and
disabling the camera to output moving trajectory of the inputting object when the inputting object moves outside of the spatial region.

7. A device for recognizing character input, wherein comprising
a camera for capturing and outputting a moving trajectory of an inputting object;
a sensor for detecting and outputting a distance between the inputting object and the sensor;
a processor for a) determining the moving trajectory of the inputting object outputted by the camera when the distance outputted by the sensor is within a range having a farthest distance value and a nearest distance value; b) mapping a character based on the determined moving trajectory.

8. The device of the claim 7, wherein the processor is further used for
c) putting the device in a working mode among the working mode and a standby mode for character recognition upon detection of a first gesture; and
d) determining the farthest distance value and the nearest distance value based on the distance outputted by the sensor at the time when the first gesture is detected.

9. The device of the claim 7, wherein the processor is further used for
c′) putting the device in a working mode among the working mode and a standby mode for character recognition upon detection of a first gesture;
d′) detecting the inputting object is held still for a period of time; and
e) determining the farthest distance value and the nearest distance value based on the distance outputted by the sensor at the time when the inputting object is detected to be held still.

10. The device of the claim 7, wherein the processor is further used for
g) determining a current stroke is a beginning stroke of a new character, wherein a stroke corresponds to the moving trajectory of the inputting object during a period beginning when the distance outputted by the sensor becomes to be within the range and ending when the distance outputted by the sensor becomes to be out of the range.
